(19) United States
(12) Patent Application Publication
(10) Pub. No.: US 2009/0307060 A1
(43) Pub. Date: Dec. 10, 2009

(54) METHODS AND SYSTEMS FOR DETERMINING A LOYALTY PROFILE FOR A FINANCIAL TRANSACTION CARDHOLDER

(76) Inventors: Christopher J. Merz, Wildwood, MO (US); Walter Lo Faro, Chesterfield, MO (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 12/479,467

(22) Filed: Jun. 5, 2009

Related U.S. Application Data
(60) Provisional application No. 61/060,027, filed on Jun. 9, 2008.

(51) Int. Cl. G06Q 30/00; G06Q 10/00; G06F 17/30; G06F 17/40; G06Q 40/00

(52) U.S. Cl. 705/10; 705/30; 707/104.1; 707/E17.044

(57) ABSTRACT

A computer-based method and system for determining a loyalty profile for a cardholder is provided. The cardholder having an account associated with a payment card. The payment card is issued by an issuer to the cardholder. The method is performed using a computer coupled to a database. The method includes electronically receiving transaction information of the cardholder at the computer wherein the transaction information includes data representing each transaction initiated by the cardholder and associated with the cardholder account, electronically storing the transaction information within the database, and transforming the transaction information at the computer to generate the loyalty profile for the cardholder wherein the loyalty profile represents a pattern of usage of the payment card and the associated account by the cardholder.

### CROSS REFERENCE TO RELATED APPLICATIONS

This application claims the priority of Provisional Patent Application Ser. No. 61/060,027, filed Jun. 9, 2008, and is hereby incorporated by reference in its entirety.

### BACKGROUND OF THE INVENTION

This invention relates generally to determining a loyalty profile for a financial transaction cardholder and, more particularly, a computer-based system and method for determining a loyalty profile for a cardholder using transaction data of the cardholder.

Historically, the use of “charge” or transaction cards or payment cards for consumer transaction payments was at most regional and based on relationships between local credit or debit card issuing banks and various local merchants. The transaction card industry has since evolved with the issuing banks forming associations or networks (e.g., MasterCard®) and involving third party transaction processing companies (e.g., “Merchant Acquirers”) to enable cardholders to widely use transaction cards at any merchant's establishment, regardless of the merchant's banking relationship with the card issuer. (MasterCard is a registered trademark of MasterCard International Incorporated located in Purchase, New York).

For example, FIG. 1 of the present application shows an exemplary multi-party payment card industry system for enabling payment-by-card transactions in which the merchants and issuer do not need to have a one-to-one special relationship. Yet, various scenarios exist in the payment-by-card industry today, where the card issuer has a special or customized relationship with a specific merchant, or group of merchants. These special or customized relationships may, for example, include private label programs, co-brand programs, proprietary card brands, rewards programs, and others. Rewards programs typically involve the award of rewards points to a consumer based upon certain incentivized actions taken by the consumer, such as the purchase of a certain value of goods or services from a particular merchant. Rewards points may be referred to by a particular rewards program as “rewards dollars,” “rewards miles,” or other descriptive name. The consumer then has the option of redeeming his or her accumulated rewards points according to rewards program rules to obtain better terms for a later transaction. The costs of providing such rewards program incentives to the cardholder may be borne solely by the issuer, jointly by the issuer and a merchant or third party, or solely by a merchant or third party, depending upon the type and sponsorship of the rewards program.

In addition, at least some known issuers of payment cards, such as credit cards, have also attempted to create payment card programs that are directed to a particular segment of society. These credit card programs may include certain features such as rewards points or purchasing incentives (i.e., discounts on certain purchases) that are believed to be attractive to a certain segment of society.

These types of programs that are associated with payment cards are typically used by a card issuer, merchants, or third parties to entice cardholders to use a particular payment card. The goal of these types of programs is to build loyalty with a cardholder. Cardholder loyalty may be described to include a cardholder who frequently uses a specific payment card for a variety of purchases over a period of time.

The parties that provide these programs, such as card issuers, desire a system that monitors the usage of their cards to determine the loyalty of a cardholder. These parties may also be interested in predicting when a cardholder will stop using a particular payment card such that an incentive (rewards programs or a gift) can be offered to the cardholder in an effort to keep the cardholder as a loyal customer.

### BRIEF DESCRIPTION OF THE INVENTION

In one aspect, a computer-based method for determining a loyalty profile for a cardholder is provided. The cardholder having an account associated with a payment card. The payment card is issued by an issuer to the cardholder. The method is performed using a computer coupled to a database. The method includes electronically receiving transaction information of the cardholder at the computer wherein the transaction information includes data representing each transaction initiated by the cardholder and associated with the cardholder account, electronically storing the transaction information within the database, and transforming the transaction information at the computer to generate the loyalty profile for the cardholder wherein the loyalty profile represents a pattern of usage of the payment card and the associated account by the cardholder.

In another aspect, a network-based system for determining a loyalty profile for a cardholder account. The cardholder account associated with a payment card used to initiate financial transactions over a third-party interchange network. The payment card issued by an issuer to the cardholder. The system comprising a client computer system, a database, and a server system configured to be coupled to the client computer system and the database. The server system is associated with the interchange network. The server system configured to receive transaction information of the cardholder wherein the transaction information includes data representing each transaction initiated by the cardholder and associated with the cardholder account, store the transaction information within the database, and transform the transaction information to generate the loyalty profile for the cardholder account wherein the loyalty profile represents a pattern of cardholder account usage by the cardholder.

In another aspect, a computer for determining a loyalty profile for a cardholder is provided. The cardholder having an account associated with a payment card. The payment card is issued by an issuer to the cardholder. The computer is coupled to a database and programmed to receive transaction information of the cardholder wherein the transaction information includes data representing each transaction initiated by the cardholder and associated with the cardholder account including data representing a type of transaction being initiated, a purchasing frequency, types of purchases, redemption of bonus points or incentives, contacts with call centers, survey responses, and web site activity. The computer further programmed to store the transaction information within the database, and transform the transaction information to generate the loyalty profile for the cardholder, the loyalty profile representing a pattern of usage of the payment card and the associated account by the cardholder.

In another aspect, a computer program embodied on a computer readable medium for determining a loyalty profile for a cardholder is provided. The cardholder having an account associated with a payment card. The payment card is issued by an issuer to the cardholder. The program includes at least one code segment executable by a computer to instruct the computer to receive transaction information of the cardholder wherein the transaction information includes data representing each transaction initiated by the cardholder and associated with the cardholder account, record the transaction information, and generate the loyalty profile for the cardholder wherein the loyalty profile represents a pattern of usage of the payment card and the associated account by the cardholder.

In another aspect, a method for determining a loyalty profile for a financial cardholder based on transaction activity is presented. The method includes receiving transaction information of a cardholder from an acquirer, determining types of merchants a payment card is used at by the cardholder, retrieving profile information of the cardholder, determining activity by the cardholder at a call center associated with the payment card, determining activity by the cardholder on a web site associated with the payment card, and determining redemption history of the cardholder with the payment card. A loyalty profile engine is programmed to determine an up-to-date view of the cardholder, card usage patterns, and the current state of the account, including spending patterns, promotion to effect, and status. The output is used to provide a real-time environment for conducting loyalty campaigns and analysis of increasing activation, usage, and retention.

In another aspect, a computer for determining a loyalty profile for a financial cardholder based on transaction activity is provided. The computer includes a processor and is coupled to a loyalty profile engine and a database. The computer is programmed to receive transaction information of a cardholder from an acquirer, determine types of merchants a payment card is used at by the cardholder, retrieve profile information of the cardholder, determine activity by the cardholder at a call center associated with the payment card, determine activity by the cardholder on a web site associated with the payment card, and determine redemption history of the cardholder with the payment card. A loyalty profile engine is programmed to determine an up-to-date view of the cardholder, card usage patterns, and the current state of the account, including spending patterns, promotion to effect, and status. The output is used to provide a real-time environment for conducting loyalty campaigns and analysis of increasing activation, usage, and retention.

In another aspect, a computer program embodied on a computer readable medium for determining a loyalty profile for a financial cardholder based on transaction activity is provided. The computer program is processed using a loyalty profile engine. The computer program includes at least one code segment that receives transaction information of a cardholder from an acquirer, determines types of merchants a payment card is used at by the cardholder, retrieves profile information of the cardholder, determines activity by the cardholder at a call center associated with the payment card, determines activity by the cardholder on a web site associated with the payment card, and determines redemption history of the cardholder with the payment card. A loyalty profile engine is programmed to determine an up-to-date view of the cardholder, card usage patterns, and the current state of the account, including spending patterns, promotion to effect, and status. The output is used to provide a real-time environment for conducting loyalty campaigns and analysis of increasing activation, usage, and retention.

### BRIEF DESCRIPTION OF THE DRAWINGS

FIG. 1 is a schematic diagram illustrating an exemplary multi-party payment card industry system for enabling ordinary payment-by-card transactions in which the merchants and issuer do not need to have a one-to-one special relationship.

FIG. 2 is a simplified block diagram of an exemplary embodiment of a server architecture of a system, in accordance with one embodiment of the present invention.

FIG. 3 is an expanded block diagram of an exemplary embodiment of a server architecture of a system, in accordance with one embodiment of the present invention.

FIG. 4 is a block diagram showing an exemplary Loyalty Profile Engine and a model package data warehouse in accordance with the system shown in FIG. 2.

FIG. 5 is a block diagram further showing the exemplary Loyalty Profile Engine and the model package data warehouse.

FIG. 6 is an example embodiment of a first report generated from the Loyalty Profile Engine showing a snapshot of a loyalty profile for a cardholder.

FIG. 7 is an example embodiment of a second report generated from the Loyalty Profile Engine showing a subsequent snapshot of a loyalty profile for a cardholder.

FIG. 8 is an example embodiment of a third report generated from the Loyalty Profile Engine showing another subsequent snapshot of a loyalty profile for a cardholder.

FIG. 9 is an example embodiment of a fourth report generated from the Loyalty Profile Engine showing another subsequent snapshot of a loyalty profile for a cardholder.

### DETAILED DESCRIPTION OF THE INVENTION

The methods and systems described herein relate to a financial transaction card payment system, such as a credit card payment system using the MasterCard® interchange (MasterCard is a registered trademark of MasterCard International Incorporated located in Purchase, New York). The MasterCard® interchange is a proprietary communications standard promulgated by MasterCard International Incorporated® for the exchange of financial transaction data between financial institutions that have registered with MasterCard International Incorporated®.

Described herein are exemplary embodiments of systems and processes for providing a transaction-based approach to determine a loyalty profile of a cardholder. More specifically, the exemplary systems and methods are used for continuously monitoring the purchasing behavior including transactions, purchasing frequency, types of purchases, redemptions, contacts with call centers, survey responses, and web site activity, and then determining a loyalty profile for the cardholder based on the cardholder's purchasing behavior. As the cardholder's use of the issuer's card changes over time, the exemplary systems and methods provide the card issuer with a profile of the cardholder and provides the card issuer with an indication of whether the cardholder is moving away from using the card issuer's payment card, changing spending activities, and changing the types of merchants a cardholder frequents. The card issuer may use the output of the system to provide an incentive to the cardholder to increase the cardholder's use of the issuer's card, for example, the card issuer may issue a gift card or gift certificates related to the types of merchants the cardholder frequents or providing a “reward” for using the issuer's card in order to increase the cardholder's usage of the card.

The systems and processes described herein relate to a cardholder that utilizes a payment card to make a purchase from a merchant, wherein the merchant has registered with a bankcard network such that the purchase made by the cardholder using the payment card can be processed over the bankcard network (also referred to as a third-party payment card interchange or interchange network). The payment card has associated therewith a financial account in a financial institution and may include one or more rewards features. The financial transaction payment system that processes the transaction includes a processing unit, an application program for execution on the processing unit, and a database for storing information relating to the cardholders, information relating to the payment card and the financial account associated therewith, retail transaction information, redemption of bonus points and/or incentives, call center activity by the holder, survey responses, web site navigation, and previously determined profiles.

A technical effect of the systems and processes described herein include at least one of (a) registering a cardholder with a multi-party payment card interchange, (b) providing a financial transaction payment system at the multi-party payment card interchange that includes a processing unit, an application program for execution on the processing unit, and a database for storing information relating to cardholders, wherein the payment system includes a Loyalty Profile Engine (LPE) and a plurality of models; (c) receiving transaction information for cardholders registered with the multi-party payment card interchange, wherein the transaction information includes at least one of cardholder information, retail transactions, redemption of bonus points and/or incentives, call center activity by the cardholder, survey responses, web site navigation, and previously determined profiles; (d) processing the transaction information using the LPE, wherein the LPE applies at least one of the plurality of models to the transaction information for a specific cardholder; (e) generating a current loyalty profile for the specific cardholder based on the processed transaction information, wherein output from the models is applied to a previously determined loyalty profile for the cardholder to generate the current loyalty profile; and (f) outputting reports representing the current loyalty profile for each of the cardholders on a periodic basis showing the change in transaction activity by the cardholders that includes a spend breadth indicator, a spend ratio indicator, and an attrition indicator to at least one of a card issuer, a merchant, and the multi-party payment card interchange for maintaining a relationship with the cardholder.

In one embodiment, a computer program is provided, and the program is embodied on a computer readable medium and utilizes a Structured Query Language (SQL) with a user interface front-end for administration and a report generator. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIX server environment (UNIX is a registered trademark of AT&T New York, N.Y.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

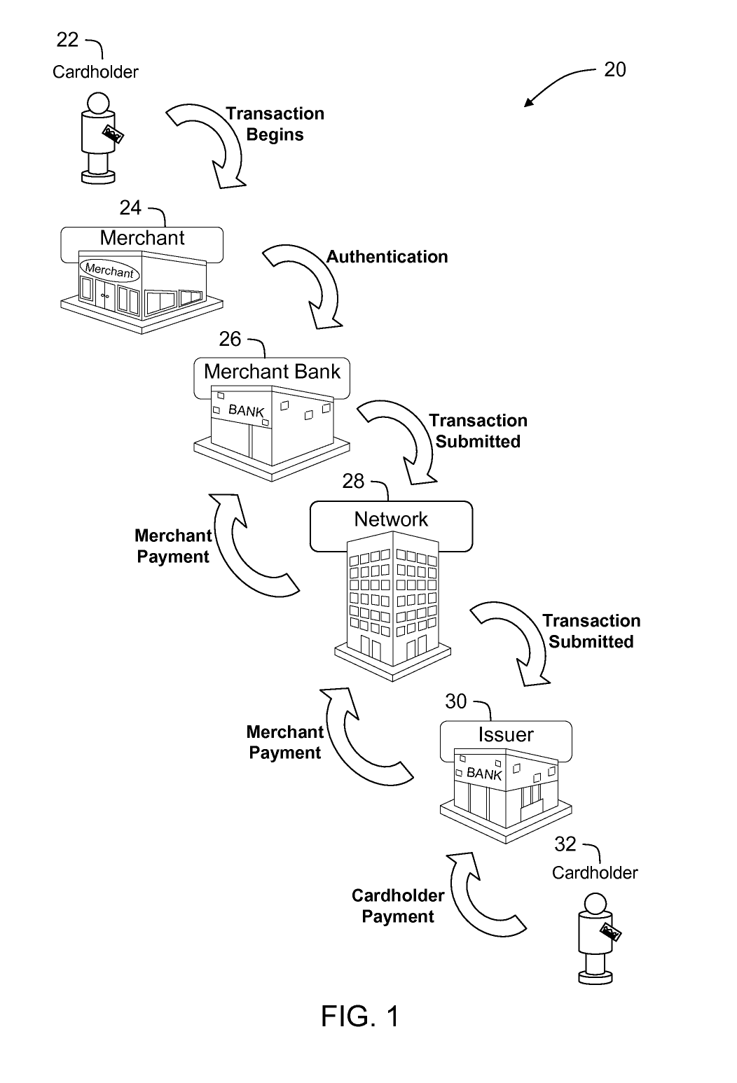

FIG. 1 is a schematic diagram 20 illustrating an exemplary multi-party payment card industry system for enabling ordinary payment-by-card transactions in which the merchants and issuer do not need to have a one-to-one special relationship. The present invention relates to a payment card system, such as a credit card payment system using the MasterCard® interchange network. The MasterCard® interchange network is a set of proprietary communications standards promulgated by MasterCard International Incorporated® for the exchange of financial transaction data and settlement of funds between financial institutions that are members of MasterCard International Incorporated®. (MasterCard is a registered trademark of MasterCard International Incorporated located in Purchase, New York).

In a typical payment card system, a financial institution called the “issuer” issues a payment card, such as a credit card, to a consumer, who uses the payment card to tender payment for a purchase from a merchant. To accept payment with the credit card, the merchant must normally establish an account with a financial institution that is part of the financial payment system. This financial institution is usually called the “merchant bank” or the “acquiring bank” or “acquirer bank.” When a consumer 22 tenders payment for a purchase with a credit card (also known as a financial transaction card), the merchant 24 requests authorization from the merchant bank 26 for the amount of the purchase. The request may be performed over the telephone, but is usually performed through the use of a point-of-sale terminal, which reads the consumer's account information from the magnetic stripe, chip, or embossed characters on the credit card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor” or a “third party processor.”

Using the interchange network 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge for a credit card transaction is not posted immediately to a consumer's account because bankcard associations, such as MasterCard International Incorporated®, have promulgated rules that do not allow a merchant to charge, or “capture,” a transaction until goods are shipped or services are delivered. However, with respect to at least some debit card transactions, a charge may be posted at the time of the transaction. When a merchant ships or delivers the goods or services, the merchant captures the transaction by, for example, appropriate data entry procedures on the point-of-sale terminal. This may include bundling of approved transactions daily for standard retail purchases. If a consumer cancels a transaction before it is captured, a “void” is generated. If a consumer returns goods after the transaction has been captured, a “credit” is generated. The issuer bank 30 stores the credit card transaction information, such as the type of merchant, amount of purchase, date of purchase, in a data warehouse.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group. More specifically, a transaction is typically settled between the issuer and the interchange network, and then between the interchange network and the merchant bank (also known as the acquirer bank), and then between the merchant bank and the merchant.

Financial transaction cards or payment cards can refer to credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

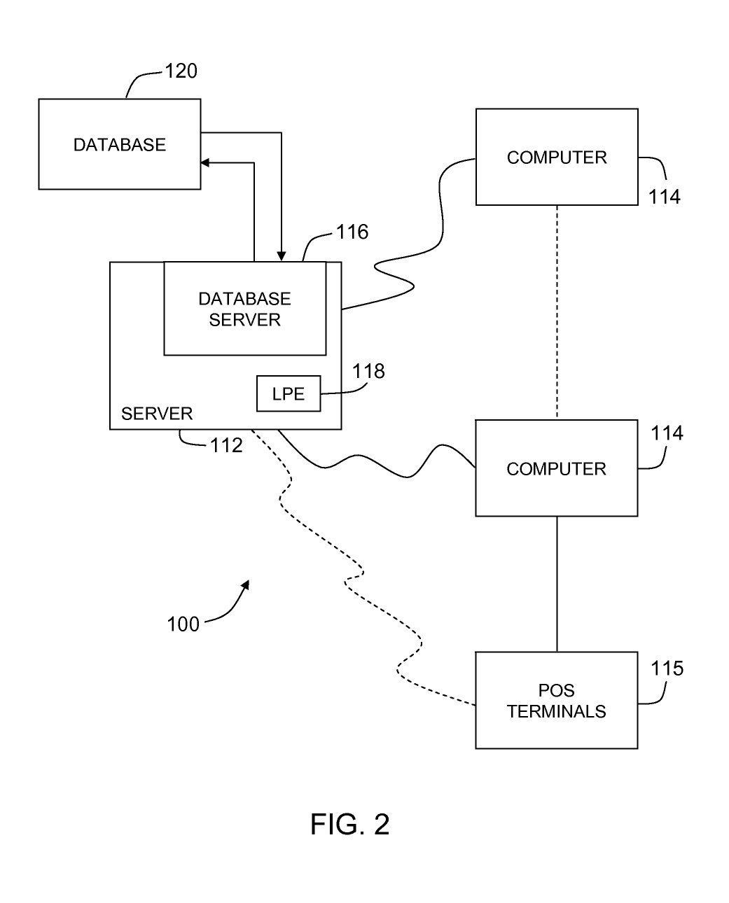

FIG. 2 is a simplified block diagram of an exemplary system 100, in accordance with one embodiment of the present invention. In one embodiment, system 100 is a payment card system, also referred to as a financial transaction payment system, used for storing transaction data of users, within a payment card program used by cardholder. In another embodiment, system 100 is a payment card system configured to process a transaction initiated by a cardholder using a payment card, determine whether the cardholder engaging in the transaction is registered within the system, store the data related to the transaction, and generate and/or update a loyalty profile of the cardholder.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any device capable of interconnecting to the Internet including a web-based phone, personal digital assistant (PDA), or other web-based connectable equipment. A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized. Server system 112 also includes a Loyalty Profile Engine (LPE) 118 for generating a loyalty profile for a cardholder, which will be described in greater detail below.

System 100 also includes point-of-sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems and special high-speed ISDN lines. POS terminals 115 could be any device capable of interconnecting to the Internet and includes an input device capable of reading information from a consumer's financial transaction card.

As discussed herein, database 120 stores information relating to cardholders, rewards features associated with each cardholder's payment card, and rewards data. Database 120 may also store transaction data generated as part of sales activities conducted over the bankcard network including data relating to merchants, account holders or customers, and purchases. Database 120 may also include redemption of bonus points and/or incentives, call center activity by the holder, survey responses, web site navigation, and previously determined profiles.

In the example embodiment, one of client systems 114 may be associated with an acquirer while another one of client systems 114 may be associated with an issuer, POS terminal 115 may be associated with a participating merchant, and server system 112 may be associated with the interchange network.

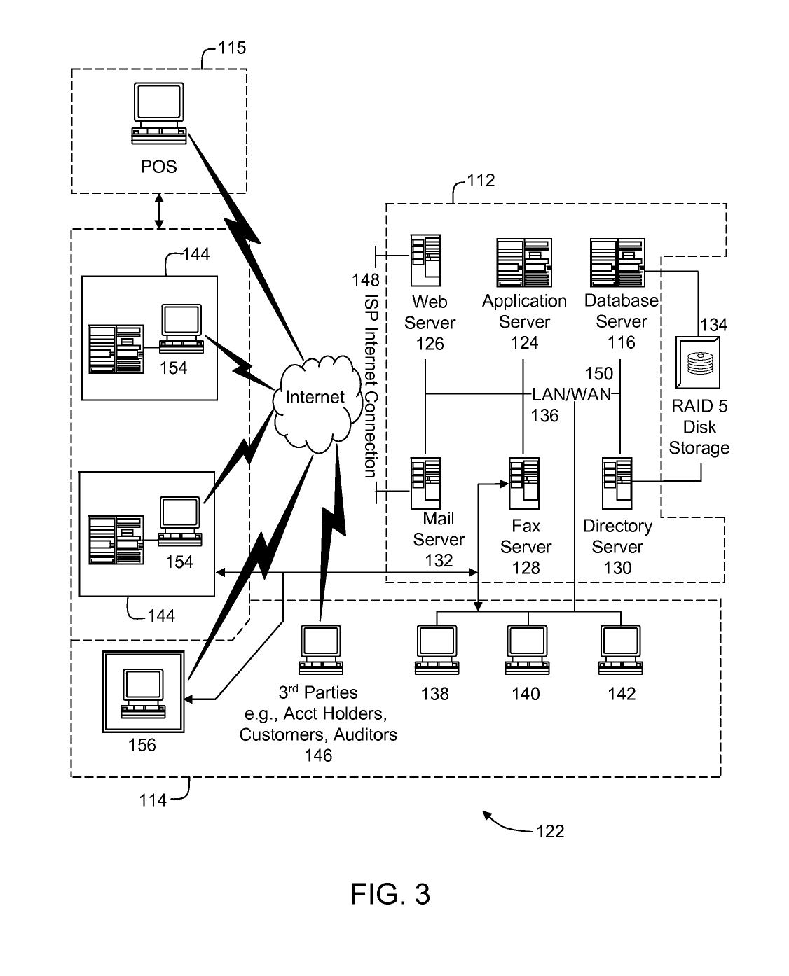

FIG. 3 is an expanded block diagram of an exemplary embodiment of a server architecture of a system 122, in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 115. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

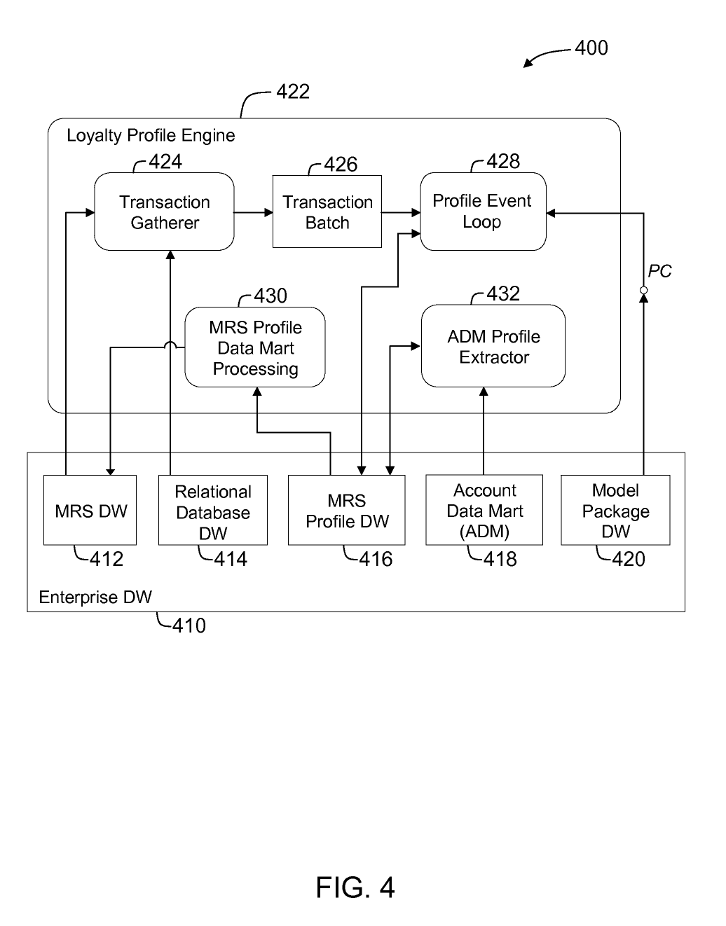

FIG. 4 is a block diagram 400 showing an exemplary Loyalty Profile Engine (LPE) included within system 100 (shown in FIG. 2) for determining loyalty profiles for payment cardholders using transaction data of the cardholder. Block diagram 400 includes an enterprise data warehouse (DW) 410 and an LPE 422 (also sometimes referred to as a profiling wrapper). The DW 410 includes a MRS DW 412 for storing cardholder information, relational databases DW 414 including transactional information, MRS Profile DW 416 for storing cardholder profiles, Account Data Mart (ADM) 418 for storing account information, and Model Package DW 420 for storing model data. The information stored within DW 410 includes cardholder information, transactional information, existing cardholder profiles, account information, and model data. This stored information also includes purchasing frequency, types of purchases, redemptions, contacts with call centers, survey responses, and web site activity. This stored information is collectively referred to herein as transaction information. MRS DW 412 is also known as the MasterCard® Rewards System Data Warehouse which is used for storing cardholder information. Relational databases DW 414 is sometimes referred to as the Oracles® Data Warehouse which is used for storing transactional information. (Oracle is a registered trademark of Oracle International Corporation located in Redwood City, Calif.)

LPE 422 determines the cardholder profile and outputs a concise, up-to-date view of the cardholder, card usage patterns, and current state of the account. LPE 422 includes a Transaction Gatherer component 424 (TG) to collect current activity associated with a cardholder. The TG 424 collects data from the MRS DW 412, such as cardholder information, and the transactional data stored at the relational databases DW 414. Once the TG 424 has collected all current activity and the cardholder information, the TG 424 passes the information to the Transaction Batch component 426 for processing. The Transaction Batch component 426 receives the collected cardholder information and any transaction information associated with the cardholder, and places the information into a format compatible for processing within the Profile Event Loop component 428. Once the Profile Event Loop component 428 receives the data from the Transaction Batch component 426, the received information is processed with one or more of the models stored within Model Package DW 420 to generate a loyalty profile for a customer.

The Profile Event Loop component 428 determines the current loyalty profile for the cardholder using input from the Transaction Batch component 426 and the Model Package DW 420. After determining the current loyalty profile for the transaction cardholder, the Profile Event Loop component 428 updates an existing loyalty profile for the cardholder, and causes the updated loyalty profile to be stored within the MRS Profile DW 416. To accumulate and make all cardholders associated with a single account profiles consistent, an ADM Profile Extractor component 432 receives data from the ADM 418 and the MRS Profile DW 416, determines a single profile for the account, and updates the profile for the cardholders at the MRS Profile DW 416. The updated MRS Profile DW 416 is used by the MRS Profile Data Mart Processing 430 to process updating the MRS DW 412.

The Model Package DW 420 includes various models that are used for generating a loyalty profile for cardholders. The models include, but are not limited to: (1) Retail Model: The retail model package uses data fields from the Transaction Gatherer component related to the retail activity of an account for generating at least a portion of the loyalty profile. From these data fields, the retail model updates MRS Profile DW 416 variables that synopsize the retail behavior of the account. (2) Redemption Model: The redemption model package uses data fields from the Transaction Gatherer component related to the redemption activity of a customer for generating at least a portion of the loyalty profile. From these data fields, the redemption model updates MRS Profile DW 416 variables that synopsize the redemption behavior of the account. (3) Customer Model: The customer model package uses data fields from the Transaction Gatherer component related to general customer information for generating at least a portion of the loyalty profile. From these data fields, the customer model updates MRS Profile DW 416 variables that synopsize this information. (4) Call Center Model: The call center model package uses data fields from the Transaction Gatherer component related to the call center activity of an account for generating at least a portion of the loyalty profile. From these data fields, the call center model updates MRS Profile DW 416 variables that synopsize the call center behavior of the account. The activity covered by this model package should include only those calls initiated by the customer.

The models described herein are for exemplary purposes only, and are not intended to limit the system in anyway. Other models could also be used or added to the system. Specifically, Model Package DW 420 may include other models that could be used for processing other types of information relating to cardholder activity to generate at least a portion of a loyalty profile for the cardholder. Model Package DW 420 is configured to accept additional models without having to modify other portion of the system. Accordingly, a new model may be added to Model Package DW 420 for generating at least a portion of a loyalty profile without making modifications to any other part of the system.

In one embodiment, TG 424 retrieves data directly from MRS DW 412 and relational databases DW 414. In another embodiment, TG 424 retrieves data indirectly from MRS DW 412 and relational databases DW 414.

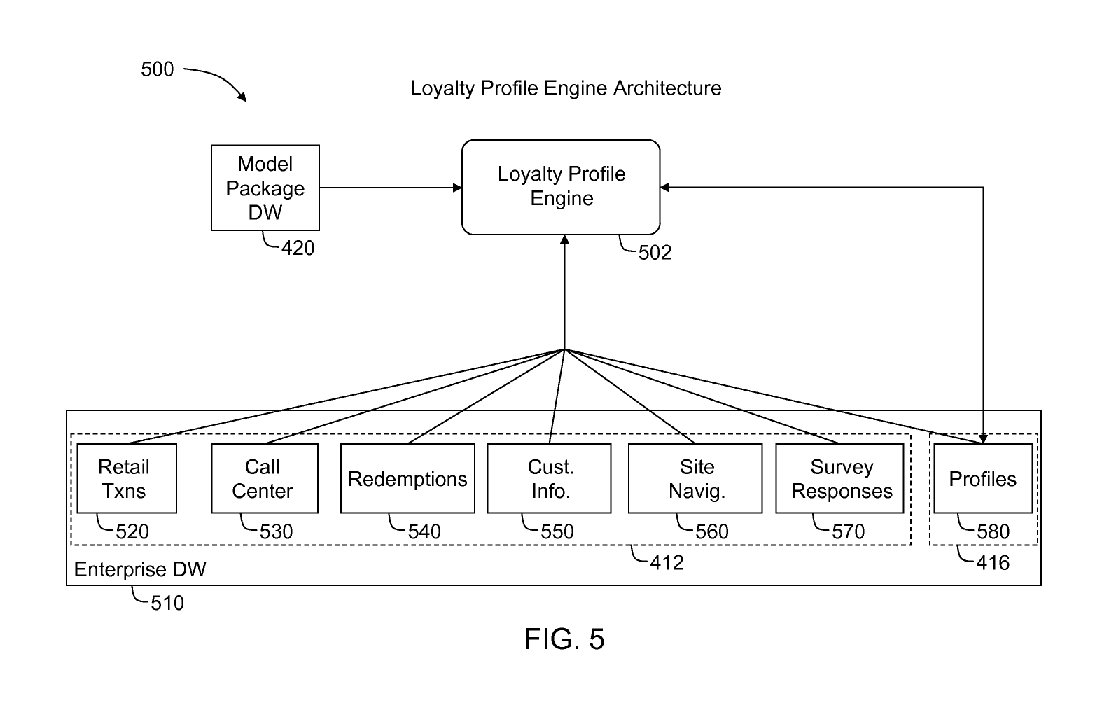

FIG. 5 is a block diagram 500 further showing the exemplary Loyalty Profile Engine (LPE) 502 and the model package data warehouse. Components in diagram 500 that are also shown in FIG. 4 are identified in FIG. 5 using the same reference numerals as used in FIG. 4. LPE 502 is coupled to Enterprise DW 510 that includes information related to a cardholder and various activities associated with the cardholder. LPE 502 accesses the Enterprise DW 510 and retrieves transaction information for the cardholder including the most current retail transactions 520, call center activity 530, redemptions 540, customer info 550, site navigation activity 560, survey responses 570, and existing profiles 580 of cardholders. LPE 502 applies at least one model to the retrieved transaction information to generate a current loyalty profile for the cardholder. The output from the at least one model is combined with an existing loyalty profile for the cardholder in order to generate the current loyalty profile for the cardholder. The current loyalty profile is then stored within the system.

In the example embodiment, the loyalty profile is a vector or a data record stored within a computer system. The loyalty profile is a string of data that represents a pattern of usage of a payment card by a cardholder. Each cardholder may have their own corresponding loyalty profile, or an account having multiple cardholders may have its own loyalty profile. In the example embodiment, the loyalty profile may include multiple data elements, wherein each data element or a set of data elements corresponds with a particular model used for processing transaction information. For example, a loyalty profile may include a data string having twenty data elements (DE1, DE2, DE3, etc.), and may be generated using four different models (Model 1, Model 2, Model 3, and Model 4), wherein the first five data elements (DE1-DE5) are associated with Model 1, the second five data elements (DE6-DE10) are associated with Model 2, the third five data elements (DE11-DE15) are associated with Model 3, and the fourth five data elements (DE16-DE20) are associated with Model 4. Therefore, in this example, the loyalty profile would include the output from Model 1 which would be used to populate data elements DE1-DE5, the output from Model 2 which would be used to populate data elements DE6-DE10, the output from Model 3 which would be used to populate data elements DE11-DE15, and the output from Model 4 which would be used to populate data elements DE16-DE20.

In the example embodiment, LPE 502 takes as input the current batch of transactions from the Enterprise DW 510, as well as the profiles. There are two sets of profiles, one for accounts and one for customers, contained in separate data sets. The profile event loop processes the transactions in order of the transaction date, modifying the profiles as it proceeds. Each active model package controls how specific profile variables are initiated and updated, even when no transaction is present. For example, the Retail Model package may specify that the Home Improvement Center spend velocity variable be modified with every profile update. After all the transactions for each customer or account have been processed, its profile is outputted to the corresponding customer or account-level SAS data set. (SAS, also knows as Statistical Analysis System, is an integrated system of software products provided by SAS Institute.)

The Loyalty Profile Engine (LPE) 502 maintains account holder profiles, primarily according to various transactions that may come through the MasterCard® Rewards System (MRS), such as retail transactions, enrollments, and redemptions, analyzing this information to support marketing efforts by identifying patterns of account holders' behavior.

The Transaction Gather component (TG) 424 (shown in FIG. 4) of LPE 502 is an interface between the MRS DW 412 (shown in FIG. 4) and the remainder of LPE 502. In a nightly batch job, it captures various kinds of events within the MRS DW 412, reformats them, and loads them into the LPE 502 staging table within relational databases DW 414. Later the LPE 502 fetches rows from this table over the network and applies the underlying events to its own SAS data set.

In addition to this nightly job, a weekly job summarizes points and point expirations for each account. The table below shows how the event loop fits into the larger LPE 502 architecture.

| | | | | | | Interface |
|---|---|---|---|---|---|---|
| Interface # | Interface Description | Internal | External | Input | Output | Type |
| 1 | Customer | ✓ | | ✓ | | Oracle |
| | | | | | | table |
| 2 | Customer_audit | ✓ | | ✓ | | Oracle |
| | | | | | | table |
| 3 | Customer_account | ✓ | | ✓ | | Oracle |
| | | | | | | table |
| 4 | Customer_account_audit | ✓ | | ✓ | | Oracle |
| | | | | | | table |
| 5 | Bank_product | ✓ | | ✓ | | Oracle |
| | | | | | | table |
| 6 | Trans_detail | ✓ | | ✓ | | Oracle |
| | | | | | | table |
| 7 | Redemption_history | ✓ | | ✓ | | Oracle |
| | | | | | | table |
| 8 | Call_history | ✓ | | ✓ | | Oracle |
| | | | | | | table |
| 9 | Enroll_point_aging | ✓ | | ✓ | | Oracle |
| | | | | | | table |
| 10 | Aggregate_merchant | ✓ | | ✓ | | Oracle |
| | | | | | | table |
| 11 | Lpe_staging (new table) | ✓ | | | ✓ | Oracle |
| | | | | | | table |

The inputs are tables in the MRS DW 412. The output is an Oracle® table designed expressly for this purpose. The LPE 502, a SAS application residing on a separate hardware platform, uses facilities native to SAS to read the LPE_staging table over the network. The TG also uses several MRS tables to control batch execution such as, Business_Partner, Application_config, Application_process_config, and Application_process_stats. These tables are not interfaces, properly speaking, because they are neither sources nor destinations of transaction data.

The LPE_staging table collects different transaction types into a single denormalized table, for ease of downloading by the LPE 502. Each row carries a column to identify the transaction type. Each type of transaction populates a different set of columns and leaves the rest null. The following columns form a unique key: Customer_id, Account_id (zero for customer-level transactions), Mrs_txn_dt—the timestamp by which the activity qualified for extraction, Mrs_txn_type—a code identifying the transaction type, Process_date (from Trans_detail), Trans_seq_number (from Trans_detail), Fr_posting_date (from Trans_detail), and Redemption_id (from Redemption_history). Of these columns, the first four are populated for all transaction types. The next three are populated only for retail transactions, and the last only for redemptions. The inclusion of the last four columns in the key serves to ensure uniqueness. However a unique index can enforce uniqueness even when some of the columns are null. There are a plurality of transaction types, eight of which may use the following transaction type codes: Enroll customer, Update customer, Enroll account, Update account, Retail transaction, Call, Redemption, and Snapshot. Each transaction type corresponds roughly to a different input table.

In the example embodiment, a customer enrollment transaction represents an insertion into the Customer table. The columns captured include the following: last name, first name, middle name, Address1, Address2, Address3, Address4, City, State, Postal Code, Country, Phone number, and Email address.

A Customer update transaction represents an update to the Customer table, and covers all the same columns as a customer enrollment. After detecting an update as recorded in the Customer_audit table, the TG 424 will fetch fresh data from the Customer table.

An account enrollment transaction represents the insertion of a row into the Customer_account table, and includes the following columns: account status, bank account number, ica code, program id, enrollment date, point total, lost or stolen, lifetime points, product code, and product type.

An account update transaction represents an update to the Customer_account table, and covers all the same columns as an account enrollment. After detecting an update as recorded in the Customer_account_audit table, the TG 424 will fetch fresh data from the Customer_account and Bank_product tables.

A retail transaction includes the following columns, mostly from the Transaction_detail table: bank account number, transaction amount, process date, aggregate merchant id, cardholder present, merchant category code, and industry.

A redemption transaction includes the following columns derived from the Redemption_history and Reward_item tables: redemption id, reward category, program id, quantity, total points redeemed, redemption code, aggregate merchant id, and reward item. Redemption history contains a Reward matrix item id column pointing to the Reward_matrix_item table, which in turn contains a reward item id column pointing to reward item.

A call center transaction represents a call from a customer to a customer service center, as reflected in the Call_history table. This table represents a variety of other kinds of events, but the TG 424 is interested only in those where cardholder call equals ‘Y’. The only column specific to this transaction type is call description id.

Snapshot transactions reflect the points available for each account including the current point balance, the total lifetime points earned, and the actual or projected expiration of points. Snapshot transactions are applied weekly rather than daily. Unlike other transaction types, a snapshot transaction does not represent any particular event. It merely represents the state of the account at the time of the extraction. The MRS transaction date reflects the system date as of the time of extraction. Snapshot transactions include the following columns, derived from the Customer_account and Enroll_point_aging tables: point total, lifetime point, total expired points, number of points expiring at the end of the current month, and number of points expiring at the end of the current quarter.

Whenever the TG 424 extracts a given transaction type, it looks for all the relevant activity that occurred at or after a designated beginning time, and before a designated ending time. This extraction window is designed to ensure that the TG 424 captures every event exactly once, with nothing missed and nothing duplicated.

Each table carries a timestamp that the TG 424 uses to qualify rows for extraction. The extraction includes all rows whose timestamp is equal to or greater than the beginning of the extraction window and less than the end of the extraction window.

The beginning of the window is defined by the ending time from the previous extraction. Between runs, the TG 424 will store this timestamp in a database table.

In the example embodiment, TG 424 performs the extraction as follows: fetch the beginning time from Application_process_stats, determine the ending time as described above, insert a row into Application_process_stats to record the new ending time, extract the activity within the extraction window, and update the row just inserted into Application_process_stats, to record that the extraction is complete.

The following sections discuss the details specific to each table.

The Customer table contains an active date column to record the creation time of each row.

The timestamp for Customer_audit is audit date. Each row represents an update of a single column. Hence a single update of a Customer may generate multiple rows in Customer table. This table is maintained by a trigger that monitors only a subset of the columns in Customer_audit table. Although the time windowing will be based on the Customer_audit table, the data loaded will come from the Customer table. The TG 424 uses the Customer_audit table to identify which customers have been updated within the window, and load a fresh image of each such customer into the LPE_staging table. In some cases the fresh image may reflect an update that occurred after the end of the time window. The next extraction cycle will also reflect the same late update, possibly resulting in an update that doesn't appear to change anything.

The timestamp for Customer_account is active date, which reflects the creation of the row.

The Customer_account_audit table is similar to the Customer_audit table, and the TG 424 extracts it the same way, using audit date as the timestamp column. If the LPE 502 needs to track any columns that are not currently audited, the trigger that maintains this table must be modified accordingly. Although the time windowing will be based on the Customer_account_audit table, the data loaded will come from the Customer_account table. The TG 424 will use the Customer_account_audit table to identify which accounts have been updated within the window, and load a fresh image of each such account into the LPE_staging table. In some cases the fresh image may reflect an update that occurred after the end of the time window. The next extraction cycle will also reflect the same late update, possibly resulting in an update that doesn't appear to change anything.

The timestamp for Trans_detail is posting dttm, which reflects the time when any points were posted for the retail transaction. If the points have not been posted for a given row, the row will not exist as far as the TG 424 is concerned, because the timestamp will be null. The TG 424 will extract it later once the points are posted.

The timestamp for Redemption_history is redeemed date.

The timestamp for Call_history is call date. The TG 424 extracts only rows where the cardholder call is ‘Y’, because those are the rows that represent calls from the customer.

With one exception, no two jobs should access the LPE_staging table at the same time, lest they miss or duplicate any activity. The exception is that the TG 424 may run the nightly job and the weekly snapshot job concurrently. For clarity of exposition, the following discussion will largely ignore this exception, but it will be a straightforward matter to allow for it.

Both the TG 424 and the LPE 502 use the Application_process_stats table to claim temporary exclusive access to the LPE_staging table. Each job inserts a row into the Application_process_stats table at the beginning to note that the job is in progress. When the job finishes, it updates the same row to mark the job as completed, and supplies an exit code. By examining Application_process_stats, each job can determine whether some other job has claimed exclusive access.

Each job will follow the following protocol to claim exclusive access: insert a row into Application_process_stats, commit the insert, read Application_process_stats to see if any other uncompleted jobs have claimed access, and if any other uncompleted jobs have claimed access, update the row just inserted to mark the job as completed and unsuccessful; otherwise assume success and continue.

If the job successfully claims access, then it either inserts rows into the LPE_staging table (in the case of the TG 424) or reads rows from the TG 424 (in the case of the LPE 502). Eventually the job updates its row in Application_process_stats to mark it as completed, with an exit code, thereby releasing the LPE_staging table for use by another job.

Insertions into Application_process_stats require appropriate entries in three other tables: Business partner, in this case to define an internal business partner, Application configuration, to define the application, Application process configuration, to associate a business partner with an application.

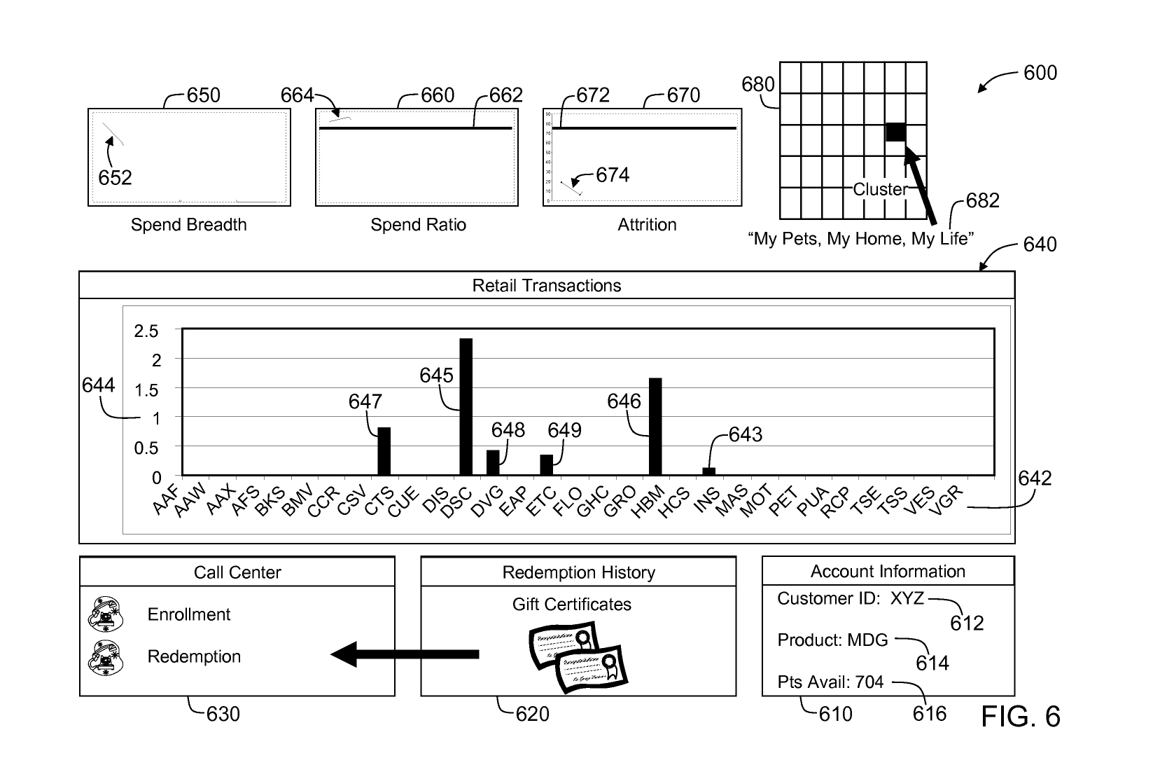

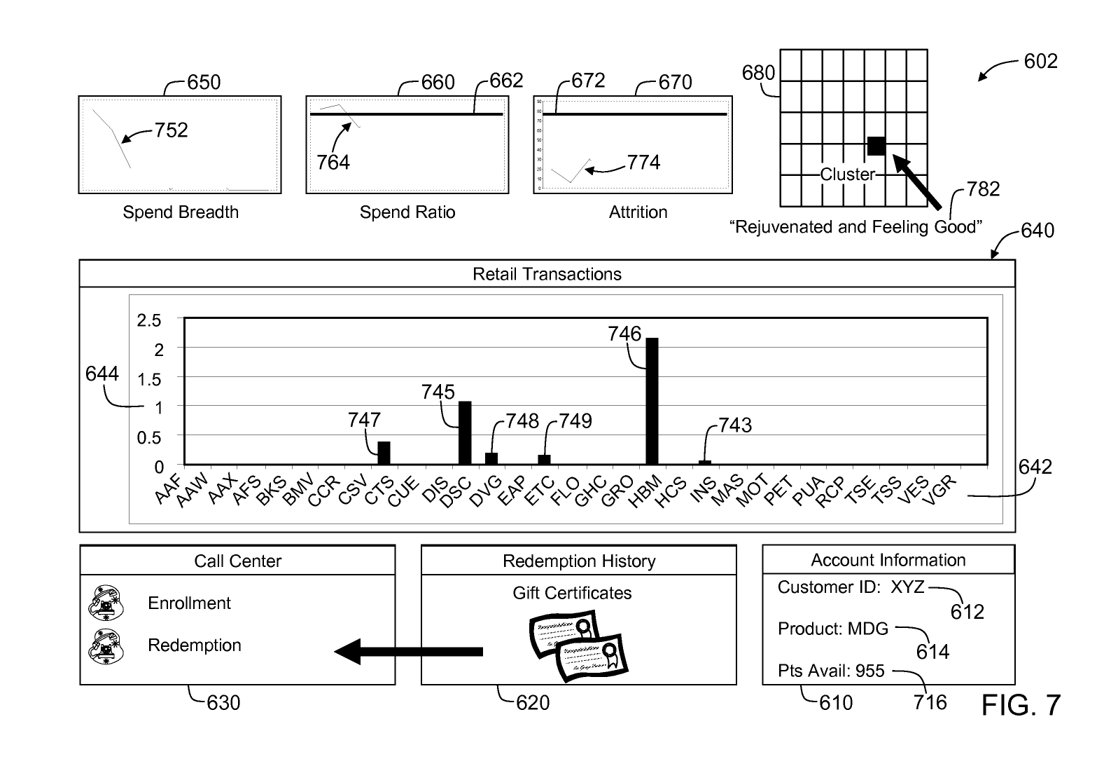

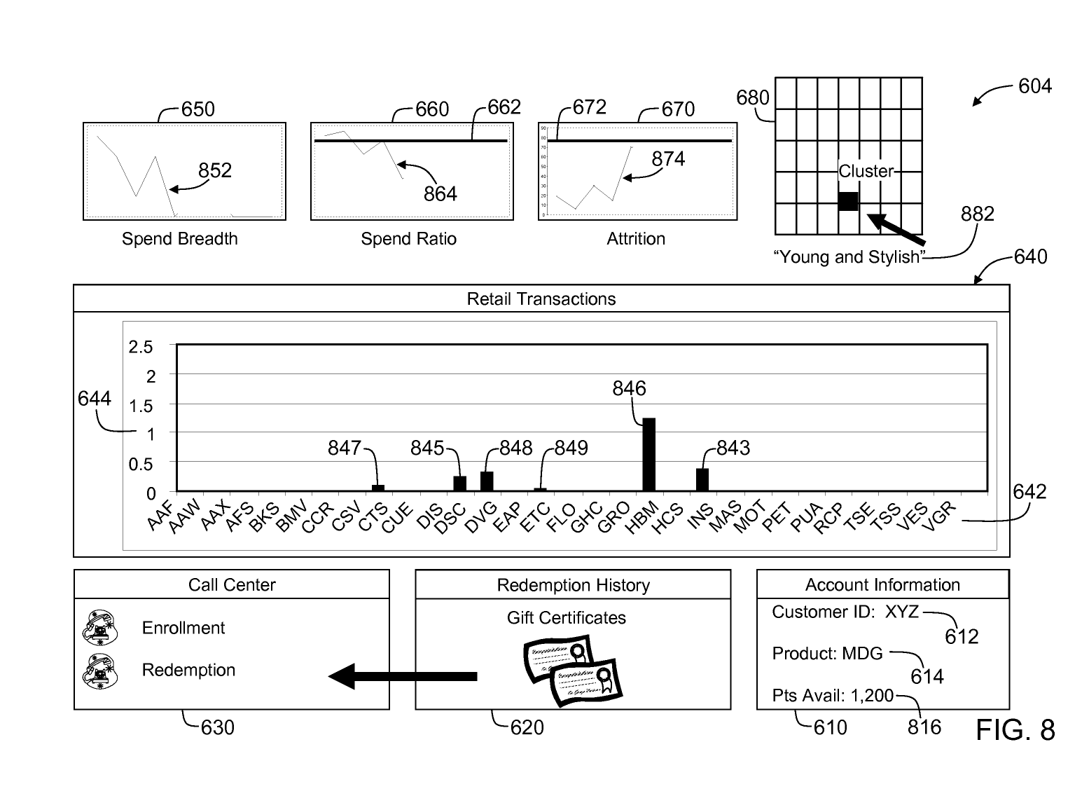

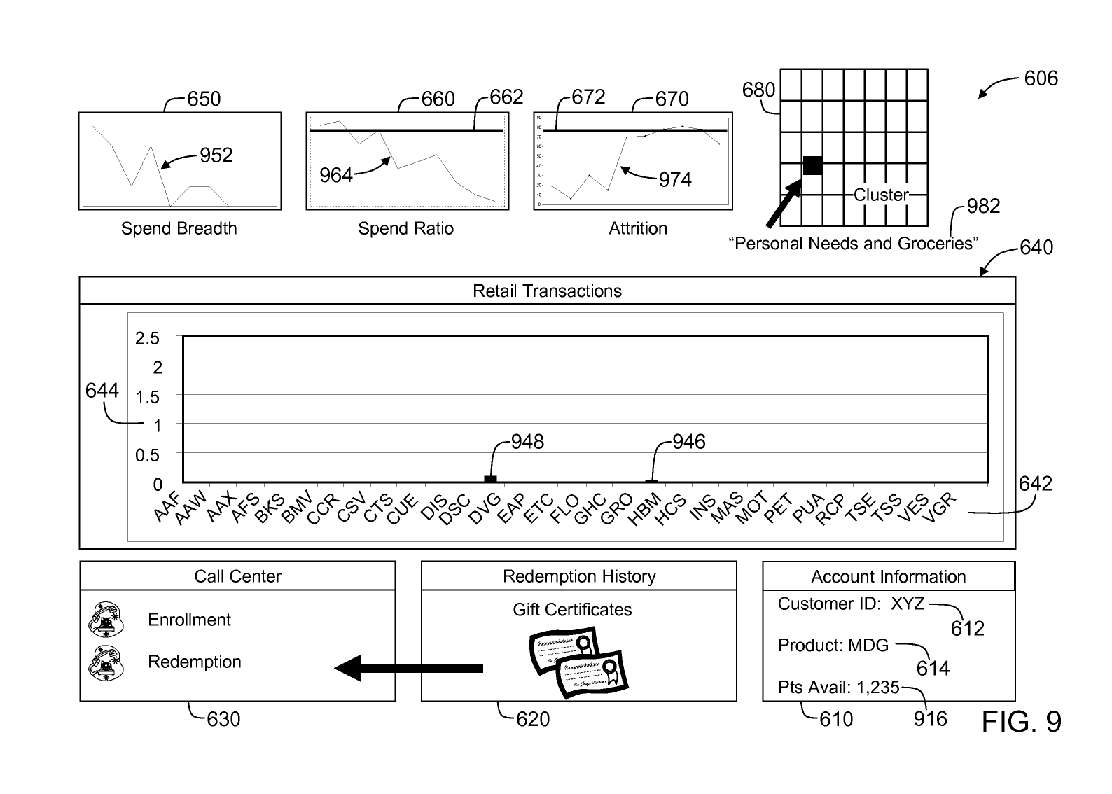

FIGS. 6 through 9 describe an exemplary case study using the Loyalty Profile Engine 502. Specifically, FIG. 6 is an example embodiment of a first report 600 generated from the Loyalty Profile Engine 502 showing a snapshot of a loyalty profile for a cardholder. FIG. 7 is an example embodiment of a second report 602 generated from the Loyalty Profile Engine 502 showing a subsequent snapshot of a loyalty profile for a cardholder. FIG. 8 is an example embodiment of a third report 604 generated from the Loyalty Profile Engine 502 showing another subsequent snapshot of a loyalty profile for a cardholder. FIG. 9 is an example embodiment of a fourth report 606 generated from the Loyalty Profile Engine 502 showing another subsequent snapshot of a loyalty profile for a cardholder.

The graphs shown in FIGS. 6 through 9 include cardholder activity data warehouse records and output from LPE 502 including the Account Information 610, Redemption History 620, Call Center 630, and Retail Transactions 640. Graphs output by the LPE 502 include the Spend Breadth indicator 650, Spend Ratio indicator 660, Attrition indicator 670, and Cluster 680.

The Account Information 610 record contains a Customer ID 612, a Product 614, and the Points (Pts) Available 616. The Account Information is used by the Call Center 630 when a cardholder calls the Call Center 630 for any reason, such as redeeming certificates, redeeming points, complaining about a purchase, enrolling in a program, etc. The Redemption History 620 is a record of the cardholder's activity in redeeming certificates and accumulated points. The Retail Transactions 640 indicates the industries 642, or type of merchants, the cardholder has made purchases from, the amount of the transactions and the number of transactions 644 that have taken place with each of the types of merchants. The types of industries include, but are not limited to, groceries, health and beauty, home improvement, etc. These different industries are represented by the abbreviations listed along the x-axis of the table.

The Spend Breadth indicator 650 illustrates the range of industries that a cardholder has made purchases from with their payment card. If the spend breadth for a cardholder is high that means that the cardholder has used their payment card at a variety of merchants. A cardholder with a high spend breadth is sometimes referred to as a cardholder having a payment card that is a “top of the wallet” payment card. Top of the wallet payment card indicates that the payment card is the one most commonly used by the cardholder. If the trend of the spend breadth is decreasing, the issuer may be concerned that the cardholder is using other payment cards more frequently and moving away or leaving the issuer's program.

The Spend Ratio indicator 660 illustrates the spending habits of a cardholder over time. An average spending level 662 is determined by the LPE 502 based on the history of spending by the cardholder. When the cardholder spending increases, the graph shows a line moving upward showing the cardholder's current spending habits in relation to their average spending level 662. If the spending ratio decreases and drops below the average spending level 662, an issuer may be concerned that the cardholder is moving away from the issuer's program.

The Attrition indicator 670 graph illustrates the determined use of the payment card by the cardholder and is used to indicate if the cardholder is moving away from the issuer's program. The LPE 502 determines a threshold value 672, indicated by the dark horizontal line near the top of the graph, that is indicative of a cardholder having left the program. A downward movement in the trend indicates that the cardholder is using the payment card more heavily and the payment card is considered to be “top of the wallet” credit card. An upward trend in the graph may indicate the cardholder is leaving or about to leave the program. As the trend moves upwardly, the issuer, merchant, and/or third party may determine to apply another program geared towards the cardholder's profile to increase transactions of the cardholder and stop the cardholder from stopping use of the payment card.

The Cluster 680 graph illustrates the industries the cardholder concentrates their purchases. As the cardholder changes the industries in which they use their payment card, the preferred industries may also change. This graph is useful in determining incentive based programs an issuer may elect to use to increase the activity of the cardholder and pull the cardholder back into the program.

Specifically, FIG. 6 shows a first report 600 generated from the LPE 502 showing a snapshot of a loyalty profile for a cardholder. In other words, report 600 shows the loyalty profile for a cardholder that is transformed into a format that is more easily interpreted by a user. Report 600 shows that the cardholder has accumulated retail transactions 644 using their payment card at the HCS 643, DIS 645, GRO 646, CSV 647, DSC 648, and EAP 649. Since the highest concentrations of transactions for this cardholder are in DIS 645, GRO 646, and CSV 647 industries, the LPE 502 details a Cluster 680 of preferred or normal spending industries by the cardholder, in this case the cardholder's preferred spending industries include My Pets, My Homes, and My Life 682. In the example embodiment, the accumulated retail transactions are outputted by LPE 502 and are weighted transactions such that actual transactions occurring more recently by the cardholder are weighted by LPE 502 more heavily than actual transactions occurring longer ago.

LPE 502 generates a graph of the Spend Breadth 650, Spend Ratio 660, and Attrition 670. The Spend Breadth 650 shows a downward trend 652, and the Spend Ratio 660 shows an upward or increasing trend 664 away from the normal or average spending level 662 of the cardholder. According to FIG. 6, the activities of this particular cardholder indicate that the cardholder is not moving away from or leaving the issuer's payment card program as shown by the downward trend 674 in the Attrition 670 chart.

FIG. 7 shows a second report 602 generated from the LPE 502 showing a subsequent snapshot of a loyalty profile for a cardholder based on the latest transaction history of the cardholder. According to report 602, the accumulated retail transactions 640 of the cardholder with the payment card shows an increase of purchasing activity at the GRO 746 industry, and a decrease in the following industries: DIS 745, CSV 747, DSC 748, HCS 743 and EAP 749 and has now accumulated 955 points 716 into their Account Information 610. In this snapshot, the highest concentrations of transactions for this cardholder is now the GRO 746 industry with fewer transactions occurring in the DSC 748, and CSV 747 industries. The LPE 502 details a Cluster 680 of preferred or normal spending industries by the cardholder. In this case, the cardholder's preferred spending industries have changed to “Rejuvenated and Feeling Good” 782 from “My Pets, My Homes, and My Life” 682 (shown in FIG. 6). The LPE 502 has generated an updated graph of the Spend Breadth 650, Spend Ratio 660, and Attrition 670 related to the cardholder. The Spend Breadth 650 shows a downward trend 752 in the number of industries the cardholder uses the payment card issued by the issuer, and the Spend Ratio 660 shows a decrease 764 in the amount charged on the payment card to below the average spending level 662 of the cardholder. The activities of the cardholder first indicate that the cardholder is moving away or leaving the issuer's card program by the upward trend 774 in the Attrition 670 chart. Thus, the issuer, merchant, or third party may want to consider whether to entice the cardholder to use the payment card more by offering a new program to the cardholder.

FIG. 8 shows a third report 604 generated from the LPE 502 showing a subsequent snapshot of a loyalty profile for a cardholder based on the latest transaction history of the cardholder. According to report 604, the accumulated retail transactions 640 of the cardholder with the payment card shows an increase of purchasing activity at the HCS 843, and DSC 848 industries, and a decrease in the following industries: CSV 847, DIS 845, GRO 846 and EAP 849 and has now accumulated 1,200 points 816 into their Account Information 610. In this snapshot, the highest concentrations of transactions for this cardholder is the GRO 846 industry with fewer transactions occurring in the HCS 843, DSC 848, and CSV 847 industries, the LPE 502 details a Cluster 680 of preferred or normal spending industries by the cardholder. In this case, the cardholder's preferred spending industries have changed to “Young and Stylish” 882 from “Rejuvenated and Feeling Good” 782 (shown in FIG. 7). The LPE 502 has generated an updated graph of the Spend Breadth 650, Spend Ratio 660, and Attrition 670 related to the cardholder. The Spend Breadth 650 shows a steep downward trend 852 in the number of industries the cardholder uses the payment card issued by the issuer, and the Spend Ratio 660 shows a decrease 864 in the amount charged on the payment card to below the average spending level 662 of the cardholder. The activities of the cardholder first indicate that the cardholder is moving away or leaving the issuer's card program by the sharp upward trend 874 in the Attrition 670 chart. Thus, the issuer, merchant, or third party may want to consider whether to entice the cardholder to use the payment card more by offering a new program to the cardholder.

FIG. 9 shows a fourth report 606 generated from the LPE 502 showing a subsequent snapshot of a loyalty profile for a cardholder based on the latest transaction history of the cardholder. According to report 606, the accumulated retail transactions 640 of the cardholder with the payment card shows an decrease of purchasing activity, where the cardholder is making purchases using the payment card only in the GRO 946, and DSC 948 industries and has now accumulated 1,235 points 916 into their Account Information 610. In this snapshot, the highest concentrations of transactions for this cardholder is the GRO 946 industry with fewer transactions occurring in the DSC 948 industry, the LPE 502 details a Cluster 680 of preferred or normal spending industries by the cardholder. In this case, the cardholder's preferred spending industries have changed to “Personal Needs and Groceries” 982 from “Young and Stylish” 882 (shown in FIG. 8). The LPE 502 has generated an updated graph of the Spend Breadth 650, Spend Ratio 660, and Attrition 670 related to the cardholder. The Spend Breadth 650 shows a steep downward trend 952 in the number of industries the cardholder uses the payment card issued by the issuer, and the Spend Ratio 660 shows a decrease 964 in the amount charged on the payment card to below the average spending level 662 of the cardholder. The activities of the cardholder indicate that the cardholder is moving away or leaving the issuer's card program by the upward trend 974 in the Attrition 670 chart. Thus, the issuer, merchant, or third party may want to consider whether to entice the cardholder to use the payment card more by offering a new program to the cardholder.

While the invention has been described in terms of various specific embodiments, those skilled in the art will recognize that the invention can be practiced with modification within the spirit and scope of the claims.

What is claimed is:

1. A computer-based method for determining a loyalty profile for a cardholder, the cardholder having an account associated with a payment card, the payment card issued by an issuer to the cardholder, said method performed using a computer coupled to a database, said method comprising:
electronically receiving transaction information of the cardholder at the computer, the transaction information including data representing each transaction initiated by the cardholder and associated with the cardholder account;
electronically storing the transaction information within the database; and
transforming the transaction information at the computer to generate the loyalty profile for the cardholder, the loyalty profile representing a pattern of usage of the payment card and the associated account by the cardholder.

2. A computer-based method according to claim 1 wherein the computer is associated with a third-party interchange network, and wherein electronically receiving transaction information further comprises:
electronically receiving, at the computer, transaction information for each transaction initiated by the cardholder and associated with the interchange network including data representing a type of transaction being initiated, a purchasing frequency, types of purchases, redemption of bonus points or incentives, contacts with call centers, survey responses, and web site activity.

3. A computer-based method according to claim 1 wherein transforming the transaction information to generate the loyalty profile further comprises:
electronically receiving first transaction information of the cardholder, the first transaction information including data representing each transaction the cardholder initiates using the payment card and each transaction associated with the cardholder account for a first predetermined period of time;
determining a first loyalty profile for the cardholder from the first transaction information;
electronically receiving updated transaction information of the cardholder, the updated transaction information including data representing each transaction the cardholder initiates using the payment card and each transaction associated with the cardholder account for a second predetermined period of time, the second predetermined period of time being more recent than the first predetermined period of time; and
determining an updated loyalty profile for the cardholder from the updated transaction information and the first loyalty profile.

4. A computer-based method according to claim 1 wherein transforming the transaction information to generate the loyalty profile further comprises:
outputting a loyalty profile report of the cardholder including an attrition indicator, the attrition indicator showing a payment card usage rate for the cardholder for a selected period of time as compared to a threshold usage rate.

5. A computer-based method according to claim 1 wherein transforming the transaction information to generate the loyalty profile further comprises:
outputting a loyalty profile report of the cardholder including a spend ratio indicator, the spend ratio indicator showing changes in cardholder spending activities by comparing a current spend amount of the cardholder with the payment card to an average spend amount of the cardholder with the payment card.

6. A computer-based method according to claim 1 wherein transforming the transaction information to generate the loyalty profile further comprises:
outputting a loyalty profile report of the cardholder including a spend breadth indicator, the spend breadth indicator showing changes in types of merchants the cardholder initiates transactions with.

7. A computer-based method according to claim 1 wherein transforming the transaction information to generate the loyalty profile further comprises:
outputting a loyalty profile report of the cardholder including an attrition indicator, a spend ratio indicator, and a spend breadth indicator;
communicating the loyalty profile report to the issuer; and
offering at least one of an incentive and an awards program to the cardholder based on the loyalty profile report.

8. A computer-based method according to claim 1 wherein electronically storing the transaction information within the database further comprises:
electronically storing cardholder data in a rewards system data warehouse;
electronically storing transactional data in a relational data warehouse;
electronically storing a current cardholder profile in a profile data warehouse;
electronically storing account information in an account data warehouse; and
electronically storing model package data in a model package data warehouse.

9. A computer-based method according to claim 8 wherein the computer includes a transaction gatherer component, a transaction batch component, and a profile event loop component, and wherein transforming the transaction information to generate the loyalty profile further comprises:
collecting at the transaction gatherer component current cardholder data stored in the rewards system data warehouse and current transactional data stored in the relational data warehouse;
transmitting the collected data from the transaction gatherer component to the transaction batch component;
formatting the collected data at the transaction batch component and transmitting the formatted data to the profile event loop component;
determining the loyalty profile for the cardholder at the profile event loop component using the formatted data and at least one model from the model package data warehouse; and
storing the determined loyalty profile in the profile data warehouse as an updated loyalty profile.

10. A computer-based method according to claim 9 wherein the computer further includes an account data profile extractor component and a rewards system data processor, and wherein processing the transaction information into the loyalty profile further comprises:
accumulating data from the account data warehouse and the rewards system data warehouse using the account data profile extractor for all cardholders associated with a single account; and
determining a single loyalty profile for the account.

11. A computer-based method according to claim 8 wherein electronically storing model package data in a model package data warehouse further comprises storing at least one of a retail model, a redemption model, a customer model, and a call center model package for generating at least a portion of the loyalty profile for the cardholder.

12. A computer-based method according to claim 8 wherein the computer includes a transaction gatherer component, and wherein transforming the transaction information at the computer further comprises at least one of:
updating the loyalty profile of the cardholder using retail activity data for the cardholder gathered by the transaction gatherer component, the retail activity data representing a retail transaction behavior of the cardholder;
updating the loyalty profile of the cardholder using redemption activity data for the cardholder gathered by the transaction gatherer component, the redemption activity data representing a redemption behavior of the cardholder;
updating the loyalty profile of the cardholder using cardholder data gathered by the transaction gatherer component; and
updating the loyalty profile of the cardholder using call center activity data for the cardholder gathered by the transaction gatherer component, the call center activity data representing a call center behavior of the cardholder.

13. A network-based system for determining a loyalty profile for a cardholder account, the cardholder account associated with a payment card used to initiate financial transactions over a third-party interchange network, the payment card issued by an issuer to the cardholder, said system comprising:
a client computer system;
a database; and
a server system configured to be coupled to the client computer system and the database, said server system associated with the interchange network, said server system configured to:
receive transaction information of the cardholder, the transaction information including data representing each transaction initiated by the cardholder and associated with the cardholder account;
store the transaction information within the database; and
transform the transaction information to generate the loyalty profile for the cardholder account, the loyalty profile representing a pattern of cardholder account usage by the cardholder.

14. A network-based system according to claim 13 wherein said server system is further configured to:
receive, from the client system, transaction information for each transaction initiated by the cardholder including data representing a type of transaction being initiated, a purchasing frequency, types of purchases, redemption of bonus points or incentives, contacts with call centers, survey responses, and web site activity.

15. A network-based system according to claim 13 wherein said server system is further configured to:
receive first transaction information of the cardholder, the first transaction information including data representing each cardholder initiated transaction for a first predetermined period of time;
determine a first loyalty profile for the cardholder account from the first transaction information;
receive updated transaction information of the cardholder, the updated transaction information including data representing each cardholder initiated transaction for a second predetermined period of time, the second predetermined period of time being more recent than the first predetermined period of time; and
determine an updated loyalty profile for the cardholder account from the updated transaction information and the first loyalty profile.

16. A network-based system according to claim 13 wherein said server system is further configured to:
output a loyalty profile report of the cardholder including an attrition indicator, the attrition indicator showing a payment card usage rate for the cardholder for a selected period of time as compared to a threshold usage rate.

17. A network-based system according to claim 13 wherein said server system is further configured to:
output a loyalty profile report of the cardholder including a spend ratio indicator, the spend ratio indicator showing changes in cardholder spending activities by comparing a current spend amount of the cardholder with the payment card to an average spend amount of the cardholder with the payment card.

18. A network-based system according to claim 13 wherein said server system is further configured to:
output a loyalty profile report of the cardholder including a spend breadth indicator, the spend breadth indicator showing changes in types of merchants the cardholder initiates transactions with.

19. A network-based system according to claim 13 wherein said server system is further configured to:
output a loyalty profile report of the cardholder including an attrition indicator, a spend ratio indicator, and a spend breadth indicator;
transmit the loyalty profile report to the client computer system; and
generate at least one of an incentive and an awards program to be offered to the cardholder based on the loyalty profile report.

20. A network-based system according to claim 13 wherein said server system is further configured to:
electronically store cardholder data in a rewards system data warehouse;
electronically store transactional data in a relational data warehouse;
electronically store a current cardholder profile in a profile data warehouse;
electronically store account information in an account data warehouse; and
electronically store model package data in a model package data warehouse.

21. A network-based system according to claim 20 wherein said server system further comprises a transaction gatherer component, a transaction batch component, and a profile event loop component, and wherein:
the transaction gatherer component is configured to collect current cardholder data stored in the rewards system data warehouse and current transactional data stored in the relational data warehouse, and transmit the collected data to the transaction batch component;
the transaction batch component is configured to format the collected data, and transmit the formatted data to the profile event loop component; and
the profile event loop component is configured to determine the loyalty profile for the cardholder using the formatted data and at least one model from the model package data warehouse, and store the determined loyalty profile in the profile data warehouse as an updated loyalty profile.

22. A network-based system according to claim 21 wherein said server system further comprises an account data profile extractor component and a rewards system data processor, and wherein the account data profile extractor is configured to:
accumulate data from the account data warehouse and the rewards system data warehouse for all cardholders associated with a single account; and
determine a single loyalty profile for the account.

23. A network-based system according to claim 20 wherein said server system is further configured to store a plurality of models within the model package data warehouse, wherein the plurality of models includes at least one of a retail model, a redemption model, a customer model, and a call center model for generating at least a portion of the loyalty profile for the cardholder.

24. A network-based system according to claim 20 wherein said server system is further configured to update at least one:
an existing loyalty profile of the cardholder using retail activity data for the cardholder, the retail activity data representing a retail transaction behavior of the cardholder;
the existing loyalty profile of the cardholder using redemption activity data for the cardholder, the redemption activity data representing a redemption behavior of the cardholder;
the existing loyalty profile of the cardholder using cardholder data; and
the existing loyalty profile of the cardholder using call center activity data for the cardholder, the call center activity data representing a call center behavior of the cardholder.

25. A computer for determining a loyalty profile for a cardholder, the cardholder having an account associated with a payment card, the payment card issued by an issuer to the cardholder, said computer coupled to a database, said computer programmed to:
receive transaction information of the cardholder, the transaction information including data representing each transaction initiated by the cardholder and associated with the cardholder account including data representing a type of transaction being initiated, a purchasing frequency, types of purchases, redemption of bonus points or incentives, contacts with call centers, survey responses, and web site activity;
store the transaction information within the database; and
transform the transaction information to generate the loyalty profile for the cardholder, the loyalty profile representing a pattern of usage of the payment card and the associated account by the cardholder.

26. A computer according to claim 25 wherein said computer is further programmed to:
receive first transaction information of the cardholder, the first transaction information including data representing each cardholder initiated transaction associated with the cardholder account for a first predetermined period of time;
determine a first loyalty profile for the cardholder from the first transaction information;
receive updated transaction information of the cardholder, the updated transaction information including data representing each cardholder initiated transaction associated with the cardholder account for a second predetermined period of time, the second predetermined period of time being more recent than the first predetermined period of time; and
determine an updated loyalty profile for the cardholder from the updated transaction information and the first loyalty profile.

27. A computer according to claim 25 wherein said computer is further programmed to:
output a loyalty profile report of the cardholder including an attrition indicator, a spend ratio indicator, and a spend breadth indicator; and
generate at least one of an incentive and an awards program to be offered to the cardholder based on the loyalty profile report.

28. A computer according to claim 25 wherein said computer further comprises a transaction gatherer component, a transaction batch component, and a profile event loop component, and wherein:
the transaction gatherer component is configured to collect current cardholder data and current transactional data stored in the database, and transmit the collected data to the transaction batch component;
the transaction batch component is configured to format the collected data, and transmit the formatted data to the profile event loop component; and
the profile event loop component is configured to determine the loyalty profile for the cardholder using the formatted data and at least one model from the model package data warehouse, and store the determined loyalty profile in the profile data warehouse as an updated loyalty profile.

29. A computer program embodied on a computer readable medium for determining a loyalty profile for a cardholder, the cardholder having an account associated with a payment card, the payment card issued by an issuer to the cardholder, said program comprises at least one code segment executable by a computer to instruct the computer to:
receive transaction information of the cardholder, the transaction information including data representing each transaction initiated by the cardholder and associated with the cardholder account;
record the transaction information; and
generate the loyalty profile for the cardholder, the loyalty profile representing a pattern of usage of the payment card and the associated account by the cardholder.

30. A computer program according to claim 29 wherein said program comprises at least one code segment executable by the computer to instruct the computer to:
receive transaction information for each transaction initiated by the cardholder including data representing a type of transaction being initiated, a purchasing frequency, types of purchases, redemption of bonus points or incentives, contacts with call centers, survey responses, and web site activity.

31. A computer program according to claim 29 wherein said program comprises at least one code segment executable by the computer to instruct the computer to:
receive first transaction information of the cardholder, the first transaction information including data representing each cardholder initiated transaction for a first predetermined period of time;
determine a first loyalty profile for the cardholder from the first transaction information;
receive updated transaction information of the cardholder, the updated transaction information including data representing each cardholder initiated transaction for a second predetermined period of time, the second predetermined period of time being more recent than the first predetermined period of time; and
determine an updated loyalty profile for the cardholder from the updated transaction information and the first loyalty profile.

32. A computer program according to claim 29 wherein said program comprises at least one code segment executable by the computer to instruct the computer to:
output a loyalty profile report of the cardholder including an attrition indicator, a spend ratio indicator, and a spend breadth indicator;
communicate the loyalty profile report to the issuer; and
offer at least one of an incentive and an awards program to the cardholder based on the loyalty profile report.

33. A computer program according to claim 29 wherein said program comprises at least one code segment executable by the computer to instruct the computer to:
store cardholder data in a rewards system data warehouse;
store transactional data in a relational data warehouse;
store a current cardholder profile in a profile data warehouse;
store account information in an account data warehouse; and
store model package data in a model package data warehouse.

34. A computer program according to claim 33 wherein said program comprises at least one code segment executable by the computer to instruct the computer to:
collect current cardholder data stored in the rewards system data warehouse and current transactional data stored in the relational data warehouse;
format the collected data for processing;
determine the loyalty profile for the cardholder using the formatted data and at least one model from the model package data warehouse; and
store the determined loyalty profile in the profile data warehouse as an updated loyalty profile.
